(19) United States
(12) Patent Application Publication
(10) Pub. No.: US 2010/0157615 A1
(43) Pub. Date: Jun. 24, 2010

(54) LUMINAIRES COMPRISING WAVEGUIDES

(75) Inventor: Russell Wayne Gruhlke, Milpitas, CA (US)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS Technologies, Inc., San Diego, CA (US)

(21) Appl. No.: 12/340,254

(22) Filed: Dec. 19, 2008

(51) Int. Cl. B60Q 1/00; F21V 33/00

(52) U.S. Cl. 362/470; 362/257; 362/511; 362/478; 362/473

(57) ABSTRACT

In certain embodiments, architectural lighting comprises a luminaire with a light source and a waveguide having forward and rearward surfaces. The waveguide can be disposed with respect to the light source such that light from the light source is input into the waveguide and guided therein. The waveguide can include a plurality of turning features that turn the light guided within the waveguide out the forward surface and one or more mounting fixtures for mounting the luminaire on an architectural structure. Some embodiments include a luminaire comprising a light source, a waveguide, turning features, and a lamp stand. Other embodiments are also described.

### BACKGROUND

1. Field of the Invention

The invention relates to the field of lighting and includes a luminaire with a light guide that can provide a thin form factor and improved light production efficiency.

2. Description of the Related Art

A variety of architectural lighting configurations are utilized to provide artificial illumination in a wide variety of indoor and/or outdoor locations. Such configurations can include fixed and portable architectural lighting. Various configurations can employ technologies such as incandescent, fluorescent, and/or light emitting diode based light sources.

One type of architectural lighting configuration can be referred to generally as panel lighting. Panel light may include for example fluorescent lighting in a light box behind a plastic lenticular panel. Panel lighting is often configured as planar and square or rectangular and having width and length dimensions significantly greater than a thickness dimension. While the thickness of panel lighting is generally significantly less than corresponding width and length dimensions, it is frequently the case that the thickness of existing panel lighting forces limitations in installation and use.

For example, the thickness of many existing panel lighting configurations is such that the panels are frequently installed in a recessed location to avoid undesirable protrusion from a surface. For example, a recess or opening can be formed in a ceiling to provide an area for installation of a panel lighting fixture. While this is a commonly employed technique for architectural lighting, it nevertheless requires time and materials for forming the recess and requires placement or removal of materials that might otherwise occupy the recess area to avoid interference with the panel lighting fixture. Such an installation is frequently incompatible with many vertical building structures, such as interior or exterior walls of a building. Structural components such as joists and studs cannot readily be removed without compromising the strength of the corresponding structural member.

A further drawback to certain existing architectural lighting configurations is that they exhibit low efficiency in conversion of electrical energy to visible light. For example, many types of lighting fixtures generate and emit light in a widely dispersed manner. By emitting light in a widely dispersed manner, a significant portion of the light can be directed in directions that the user does not necessarily need to illuminate. Such configurations do not efficiently convert the total electrical power used to desired illumination.

### SUMMARY

At least some embodiments are based at least partially on a recognition that there exists an unsatisfied need for novel configurations of architectural lighting that offer improvements in form factor and/or improvements in efficiency in conversion of electrical energy to desired illumination. For example, some embodiments provide a flat panel configuration having a particularly thin thickness dimension. Some embodiments include a waveguide that more efficiently and evenly distributes light from a light source. Some embodiments include a plurality of turning features such that generated light can be preferentially directed in one or more selected directions to more efficiently direct the generated light to a desired illumination target. Some embodiments provide for more efficient heat dissipation.

One embodiment includes architectural lighting comprising a luminaire comprising a light source and a waveguide having forward and rearward surfaces, said waveguide disposed with respect to said light source such that light from the light source is input into said waveguide and guided therein, said waveguide including a plurality of turning features that turn said light guided within said waveguide out said forward surface and one or more mounting fixtures for mounting said luminaire on an architectural structure.

Another embodiment includes architectural lighting comprising a luminaire comprising means for producing light and means for guiding light disposed with respect to said light producing means such that light from the light producing means is input into said light guiding means and guided therein, said light guiding means including a means for turning light that turns said light guided within said light guiding means out said light guiding means and means for mounting said luminaire on an architectural structure.

A further embodiment includes a method of manufacturing architectural lighting, the method comprising providing a luminaire comprising a light source and a waveguide having forward and rearward surfaces, said waveguide disposed with respect to said light source such that light from the light source is input into said waveguide and guided therein, said waveguide including a plurality of turning features that turn said light guided within said waveguide out said forward surface and providing one or more mounting fixtures for mounting said luminaire on an architectural structure.

Yet a further embodiment includes a luminaire comprising a light source and a waveguide having forward and rearward surfaces, said waveguide disposed with respect to said light source such that light from the light source is input into said waveguide and guided therein, said waveguide including a plurality of turning features that turn said light guided within said waveguide out said forward surface and a lamp stand for supporting said luminaire.

### BRIEF DESCRIPTION OF THE DRAWINGS

FIG. 1 is a perspective view schematically illustrating of one embodiment of a luminaire comprising a waveguide.

FIG. 2 is a perspective view similar to that shown in FIG. 1 that schematically illustrates light propagating within the light guide;

FIGS. 2A and 2B are cross-sectional views schematically illustrating certain aspects of the embodiment shown in FIG. 2.

FIG. 3 schematically illustrates one embodiment of a lighting assembly configured to preferentially direct light along a first and a second light emission direction.

FIG. 4A schematically illustrates an embodiment of a luminaire including a waveguide having a generally concave curvature about an axis Y.

FIG. 4B schematically illustrates an embodiment of a luminaire including a waveguide having a generally convex curvature about an axis Y.

FIG. 4C schematically illustrates an embodiment of a luminaire including a waveguide having a generally convex curvature about two axes X and Y.

FIG. 5 schematically illustrates an embodiment of a luminaire including a waveguide adapted to emit light preferentially within a first and a second emission lobe arranged at an inclination axis with respect to a major plane of the luminaire.

FIG. 6A schematically illustrates embodiments of lighting assemblies configured for mounting on horizontal and vertical structural surfaces.

FIG. 6B schematically illustrates an embodiment of lighting assembly including a mounting fixture adapted to allow the light generated to be directed in a plurality of user selectable directions.

FIG. 6C schematically illustrates an embodiment of lighting assembly configured for attachment within a recessed space.

FIG. 6D schematically illustrates an embodiment of lighting assembly that is portable and adapted to direct light generally downwards.

FIG. 6E schematically illustrates an embodiment of portable lighting assembly adapted to direct light generally upwards.

FIG. 7 schematically illustrates an embodiment of a portable electronic device provided with a lighting assembly.

### DETAILED DESCRIPTION OF CERTAIN PREFERRED EMBODIMENTS

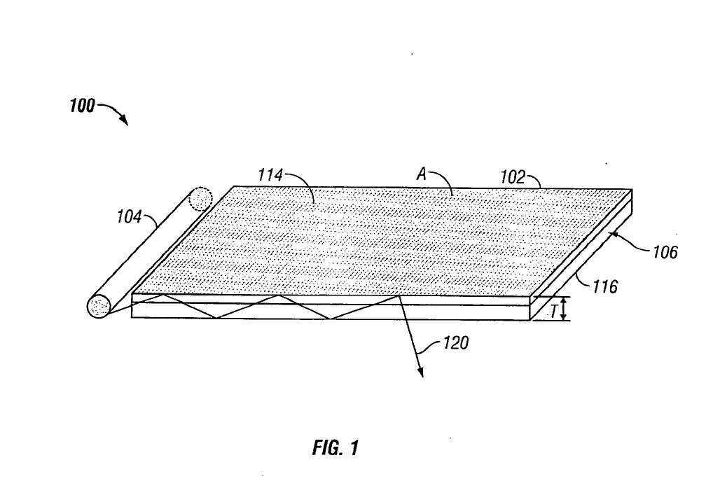

The following detailed description is directed to certain specific embodiments of the invention. However, the invention can be embodied in a multitude of different ways. In this description, reference is made to the drawings wherein like parts are designated with like numerals throughout. FIG. 1 provides a perspective schematic view of one embodiment of a lighting assembly 100 such as an architectural lighting assembly. The architectural lighting assembly 100 is configured to generate and direct light for artificial illumination of a desired area or volume.

The lighting assemblies 100 include one or more luminaires 102. The luminaires 102 are configured to generate and emit light in one or more selected light emission directions 120 as will be described in greater detail below. The lighting assemblies 100 and luminaires 102 generally comprise one or more light sources 104. The light sources 104 can be based on any of a variety of light source technology including but not limited to fluorescent lamps, incandescent bulbs, and/or light emitting diodes (LEDs). In some embodiments, the light sources 104 can describe a generally elongate or linear light source, such as a fluorescent lamp. In some embodiments, the light sources 104 comprise one or a plurality of localized light sources, such as one or more incandescent bulbs and/or light emitting diodes and/or an array of light emitting diodes. In some embodiments, a light bar is used. The light bar receives light from one end thereof and guides light therein, extracting light along an edge of the light bar as the light propagates therein. In certain embodiments, for example, an LED is disposed at one end of the light bar to couple light into the light bar. The light is guided within the light bar toward an opposite end and is ejected out a side of the light bar as it propagates in the light bar. Turning features in or on the light bar may be used to extract the light from the side of the light bar.

It will be understood that depending on the particular implementation, an appropriate source of power will be included to provide operating power to the light sources 104. Such power sources can include but are not limited to batteries, photovoltaic cells, fuel cells, generators, and/or an electrical power grid. It will also be understood that the lighting assemblies 100 will generally be provided with appropriate control circuitry which can include but need not require switches, voltage control circuitry, current control circuitry, ballast circuits, and the like. The power and control components of the lighting assemblies 100 are not illustrated for clarity and ease of understanding, however, appropriate power supply and control circuitry components will be well understood by one of ordinary skill.

In some embodiments, the luminaire 102 further comprises a waveguide 106 engaged with the one or more light sources 104. The waveguide 106 is configured to receive light generated and emitted by the light sources 104, direct the light within the waveguide 106, and redirect the light such that the light is emitted from the luminaire 102 along the one or more selected light emission directions. In some embodiments, the waveguide 106 utilizes the property of total internal reflection to direct and redirect light from the one or more light sources 104 to the selected light emission direction(s).

In some embodiments, the assembly 100 defines a rearward surface 114 and a forward surface 116. The rearward surface 114 and forward surface 116 are in some embodiments defined by the major dimensions of the luminaire 102, for example, a width and length dimension. The luminaire 102 will also generally define a thickness dimension designated by the reference designator T in FIG. 1. In one embodiment, the luminaire 102 has a thickness of at least half an inch. In one embodiment, the luminaire 102 has a thickness of at least 20 millimeters. Other dimensions outside these ranges, however, are possible.

The rearward surface 114 and forward surface 116 are shown as having a surface area indicated by the designator A in FIG. 1. In some embodiments, an area A of the rearward surface 114 and forward surface 116 are substantially similar. In other embodiments, a surface area A of the rearward surface 114 can differ from the area of the forward surface 116 in some implementations being greater and in other implementations being less than. In one embodiment, an area of the waveguide 106 is greater than 500 square inches. In one embodiment, an area of the waveguide is greater than 800 square inches. Areas outside these ranges are also possible.

In general, the surface area of the luminaire 102 will preferably be selected to satisfy the illumination needs of the user while avoiding an excessive light intensity per unit area or flux. In some embodiments, the luminaire 102 generates a light output of greater than 25 watts of visible optical power. In some embodiments, the luminaire 102 generates a light output of greater than 50 watts of visible optical power. In some embodiments, the luminaire 102 generates a light output of greater than 75 watts of visible optical power.

While illustrated in FIG. 1 as a generally rectangular and planar structure, it will be understood that the luminaire 102 can be provided in a wide variety of shapes and form factors such as generally square, triangular, circular, other regular shapes, and irregular shapes. It will also be understood that the luminaire 102 can define a generally planar structure as well as a structure curved or bent in three dimensions. Thus, it will be understood that the rearward surface 114 and forward surface 116 can be any desired shape, can differ from each other in area, and can curve, fold, or otherwise extend in three dimensions.

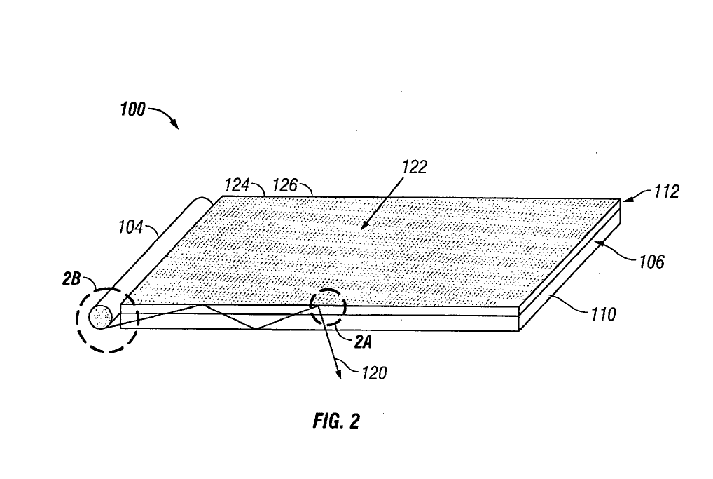

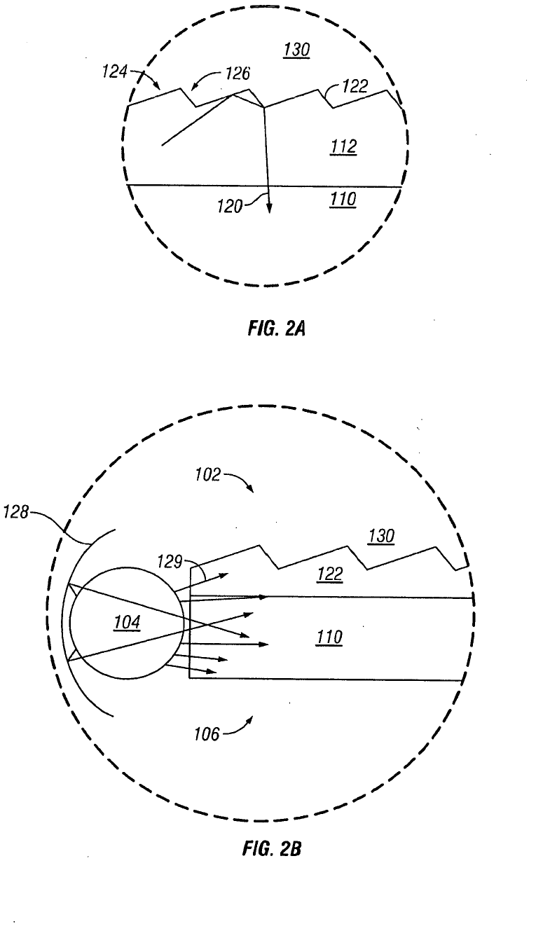

FIG. 2 and details 2A and 2B illustrate some embodiments of a lighting assembly 100 and the operation thereof. In one embodiment, the waveguide 106 comprises an optically transmissive substrate 110 and a thin film 112 disposed over the transparent substrate 110. The optically transmissive substrate 110 and thin film 112 comprise substantially optically transmissive materials which can include, for example, glass and/or plastics. In general, the optically transmissive substrate 110 and thin film 112 comprise materials having a higher index of refraction than an exterior index of refraction 130. Some embodiments are designed to operate with an exterior index of refraction 130 of air equal to approximately 1.0. For at least some directions of incidence of light from the light source 104 into the waveguide 106, the light will undergo total internal reflection within the waveguide 106 due to the different indices of refraction of materials comprising the waveguide 106 and the exterior refractive index 130.

In at least some embodiments, the luminaire 102 is provided with a plurality of light turning features 122. The light turning features 122 can comprise one or more of refractive features, holographic features, and/or prismatic features. In certain embodiments, the turning features may be disposed in the thin film 112. The turning features may be also disposed in or on the substrate 110. In one embodiment, the light turning features 122 comprise a plurality of elongate ridge or prism structures extending substantially across the rearward surface 114 of the luminaire 102.

In one embodiment, light turning features 122 comprise first facets 124 and adjacent second facets 126. The first facets 124 can be configured at a relatively shallower angle with respect to a normal to the rearward surface 114 and having a relatively longer face. In contrast, the adjacent second facets 126 can be arranged at a relatively steeper angle and have a relatively shorter surface. The first facets 124 and second facets 126 can be formed such that light can be internally reflected from one or more of the first and second facets 124, 126 such that total internal reflection of the light ceases and the light is emitted in the light emission direction 120. In various embodiments, one or more of the first and second facets 124, 126 can comprise a substantially flat or planar surface, a curved surface, or a multi-faceted surface. Other configurations are possible.

In some embodiments (see FIG. 2B), a luminaire 102 comprises one or more reflective structures 128. The one or more reflective structures 128 can be arranged with respect to the one or more light sources 104 or light bars such that light emitted from the one or more light sources 104 or light bars is directed or redirected along an appropriate input direction 129 to enter the waveguide 106. For example, in some embodiments, some portion of light emitted by the one or more light sources 104 or light bars is emitted directly along an appropriate input direction 129 to enter the waveguide 106. Some portion of light emitted by the one or more light sources 104 or light bars can be reflected or redirected at least partially by the reflective structure 128 along an appropriate input direction 129.

These aspects of the invention increase the efficiency of the luminaire 102 by directing or redirecting a greater proportion of light generated by the one or more light sources 104 into the waveguide 106 for appropriate redirection in the desired light emission direction(s) 120. The one or more reflective structures can be configured as appropriate depending on the particular configuration of light sources 104 used in a given implementation. In some embodiments, the reflective structures 128 can define a substantially parabolic cross section, a circular cross section, one or more substantially planar surfaces, and/or other shapes or contours.

In certain embodiments, one or more additional optical layers, such as a diffuser or an optical isolation layer may be included to enhance the efficiency of the waveguide 106 or to otherwise improve the optical performance of the luminaire 102. For example, a diffuser layer may be provided to scatter light providing more uniform lighting from the luminaire 102 and possibly reduce or minimize bright spots. The diffuser layer may crease a softer more diffuse lighting effect as well. As described herein, the geometric arrangement of the light turning features 122 and any additional optical films or layers may be selected to further enhance the optical performance of the luminaire 102.

The lighting assembly 100 may be formed using any of a variety of manufacturing processes known to those skilled in the art. In one embodiment, a thin film 112 may be deposited or laminated to the transparent substrate 110. For example, the thin film 112 may be laminated to a surface of the substrate 110 using a pressure sensitive adhesive. Alternatively, the thin film 112 may be deposited on the substrate 110 using other techniques known in the art or techniques yet to be developed. As described above, the thin film 112 may include the turning features formed thereon. Embossing, molding, or other techniques may be used to form the turning features in the thin film 112. In some embodiments, holographic recording techniques may be used to record diffractive optical features in the thin film 112. As described above, the turning features may be formed in or on the substrate. Similar or different techniques may be employed.

The diffuser may also be formed in or on the surface of the substrate, e.g., by etching, embossing, etc. In certain embodiments, the diffuser may also be adhered to the transparent substrate 110 at any one of several locations relative to the thin film 112. For example, the diffuser may be disposed on the substrate on the opposite side as the thin film or turning features. In some embodiments, the diffuser may be disposed between the thin film 112 and the substrate 110. The diffuser may be formed (e.g., coated, deposited or laminated, etched, etc.) on the substrate 110 using any suitable techniques known in the art or yet to be developed. For example, the diffuser may comprise a thin film grown directly on the surface of the substrate 110. In some embodiments, the diffuser may be spin cast. In certain embodiments, the diffuser comprises adhesive with particulates therein for scattering, for example a pressure-sensitive adhesive with diffusing features, used to laminate the thin film 112 to the substrate 110, while in other embodiments it may be a volume diffuser sheet laminated to the substrate 110. In some embodiments, the diffuser may also be formed using holographic recording techniques.

In various embodiments, the thin film 112 comprises a material such as polycarbonate, acrylics such as polymethymethacrylate (PMMA), or acrylate copolymers such as poly(styrene-methylmethacrylate) polymers (PS-PMMA, sold under the name of Zylar), and other optically transparent plastics. The index of refraction of polycarbonate is approximately 1.59 and for Zylar is approximately 1.54 for wavelengths in the visible spectrum. Since the index of refraction is greater than that of air, which is 1.0, light incident on the turning film/air interface at an angle greater than the critical angle will be reflected back into the light guiding portion and will continue to propagate along the width of the waveguide 106. In various embodiments, the substrate comprises similar materials. The substrate may for example also comprise polycarbonate, acrylics such as polymethymethacrylate (PMMA), or acrylate copolymers such as poly(styrene-methylmethacrylate) polymers (PS-PMMA, sold under the name of Zylar), and other optically transparent plastics in some embodiments. In certain embodiments, the indices of refraction of the one or more optical layers comprising the waveguide 106, are advantageously close such that light may be transmitted through multiple optical layers without being substantially reflected or refracted.

In certain embodiments, the turning features 122 may comprise a plurality of microprisms extending along the width of the thin film 112. The microprisms may be configured to receive light propagating along the thin film 112 and turn the light through a large angle, usually between about 70-90°. The turning features 122 may also comprise diffractive or holographic features and may comprise surface or volume features. In some embodiments, the turning features 122 comprise diffractive or holographic features disposed in or on the thin film 112 or substrate or other layer configured to receive light guided in the waveguide 106 and turn the light such that said light is redirected towards the emission direction 120. A wide variety of variations are possible.

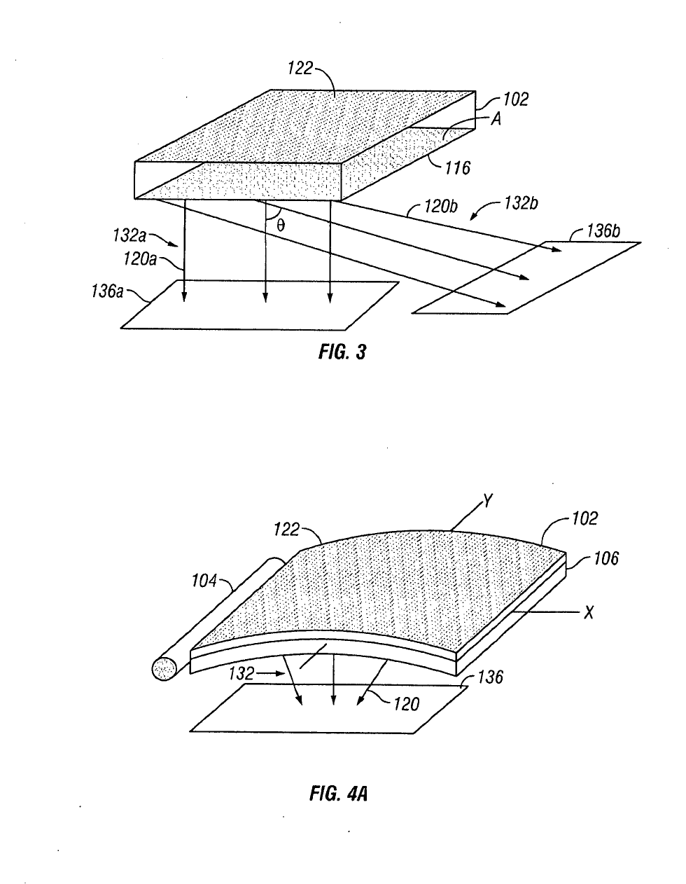

FIG. 3 illustrates a further embodiment of a luminaire comprising a waveguide. In this embodiment, the luminaire 102 is configured to preferentially emit light along a plurality of different light emission directions 120. In one embodiment, the luminaire 102 is configured to preferentially emit a first portion of light substantially along a first light emission direction 120a and to preferentially emit a second portion of light substantially along a second light emission direction 120b. A luminaire 102 can be further configured to preferentially emit the first portion of light substantially within a first emission lobe 132a and to preferentially emit a second portion of light substantially within a second emission lobe 132b.

In one embodiment, a luminaire 102 is configured to preferentially emit at least a first portion of light along a first light emission direction 120a that can be arranged substantially normal to the surface of the luminaire 102, for example, a forward surface 116. The luminaire 102 can be further configured to preferentially emit the first portion of the light within a first emission lobe 132a such that the light propagating along the first light emission direction 120a is substantially parallel. Thus, in at least certain embodiments, a luminaire 102 can be configured to emit at least a first portion of light in a manner that is substantially neither convergent nor divergent but instead substantially parallel along a single first light emission direction 120.

In some embodiments, a luminaire 102 can be adapted to preferentially emit a portion of light within a second emission lobe 132b that can be oriented at an angle θ with respect to a normal to a surface of the luminaire 102, for example, a front surface 116. This angle may be at least 20° in certain embodiments. In some embodiments, a luminaire 102 can be configured to emit at least a portion of light within a second emission lobe 132b that is divergent. Thus, in some embodiments, at least a portion of light emitted by the luminaire 102 is not substantially parallel but instead diverges.

In some embodiments, the lobes 132 may be defined by a range of solid angles less than 1 or 0.5 steradians (sr). In other embodiments, a lobe 132 can be defined by a range of solid angles less than 0.2 sr. In some embodiments, one or more lobes 132 can define a generally conical contour, e.g. a cone of rays. Accordingly, some lobes may be symmetrical. In some embodiments, one or more lobes 132 can be asymmetric and have an asymmetric cross-section. In some embodiments, one or more lobes 132 can define a generally annular or doughnut shape with a hole or dip or a generally “figure-8” shape with more than one hole or dip. Other shapes are possible.

Accordingly, the lobes 132 can be separated by dips in intensity. For example, in some embodiments, a majority of light emitted by the luminaire 102 can be emitted within one or more of the lobes 132 with relatively little light emitted in dips between lobes 132. In various embodiments, a percentage of light emitted within a lobe 132 relative to an amount of light from a light source 104 can vary between 1-90%. In some embodiments the flux between lobes 132 can approach zero. A doughnut shaped lobe 132 could have a generally centrally arranged dip of approximately 30° full width half maximum.

Different lobes 132 can also be configured to emit differing amounts of light. For example, a first lobe 132 can emit generally more light and a second lobe 132 can emit relatively less light. In some embodiments, different lobes 132 having similar size and shape can emit different amounts of light such that the intensity or flux within different lobes 132 is different. In some embodiments, different lobes 132 having different shapes and or sizes can emit light of differing intensity such that the total light emitted by each lobe 132 is similar. In some embodiments, light intensity or flux can vary within a given lobe 132. One or more lobes 132 can be superimposed on other lobes 132 at certain distances, e.g. closer distances. The emission lobe(s) 132 can be oriented at an angle θ with respect to a normal to a surface of the luminaire 102, for example, a front surface 116 that is at least 5°, 10°, 20°, 30° or 40° in some embodiments.

In some embodiments, the divergence of light within a lobe 132 is determined at least in part by the geometries of the light turning features 122 and the angular emission characteristics of the light source(s) 104. In one exemplary embodiment, a LED light source 104 can generate light that is coupled into the waveguide 106 where the angular distribution of the light is reduced from approximately ±75-650 to approximately ±35-45° The light turning features 122 can selectively pick out a portion of the light such that the angular distribution of a corresponding lobe 132 is approximately ±20° wide. In some embodiments, collimating lenses and/or reflectors can be arranged with the luminaire 102 such that one or more emission lobes have a less divergent angular distribution of approximately ±10°.

As previously noted, one or more of the facets 124 can have a curved or rounded contour. Thus, in some embodiments, light emitted within a lobe 132 can be more divergent. For example, a luminaire 102 can be configured to emit light received from a light source 104 within one or more lobes 132 having a divergence of approximately 80-90° wide. These are simply examples of some embodiments and other ranges and values are possible.

As can be seen in FIG. 3, a luminaire 102 can also be configured to preferentially emit light in an asymmetric manner. In certain embodiments, for example, the luminaire 102 is configured to emit light asymmetrically with respect to a normal to a surface of the luminaire 102. For example, a first portion of light can be preferentially emitted in a substantially parallel manner and a second portion of light can be emitted in a divergent manner. The luminaire 102 can also be configured to preferentially emit light asymmetrically in certain embodiments.

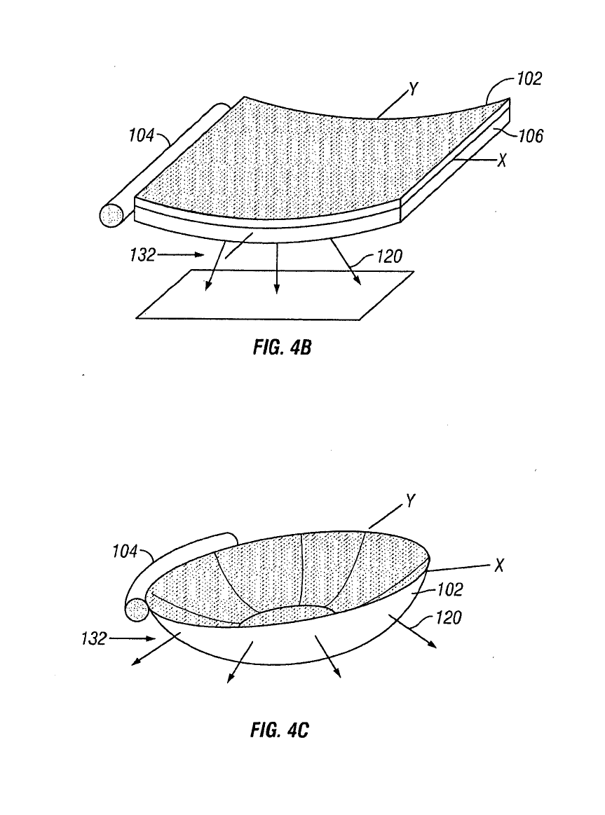

FIG. 4 illustrates additional embodiments of a luminaire 102. In this embodiment, a luminaire 102 comprising a waveguide 106 is formed to have a curvature or bend about at least a first axis Y. In one embodiment, a luminaire 102 comprising a waveguide 106 can be formed to have a generally concave curvature. In one embodiment, light can be emitted from a luminaire 102 along a light emission direction 120 such that an emission of the luminaire 102 is generally convergent. It will be understood that embodiments of a luminaire 102 can be configured such that an illumination region 136 with which a user can illuminate with the luminaire 102 is arranged within the envelope of a converging emission lobe 132. It will be further understood that in at least some implementations, the luminaire 102 can be distanced from an illumination region 136 such that a converging emission lobe 132 converges and further propagates in a divergent manner depending on the relative spacing between the illumination region 136a and 136b and the luminaire 132.

FIG. 4B illustrates a further embodiment of a luminaire 102. In one embodiment, a luminaire 102 is formed to have a generally convex curvature about at least a first axis Y. A luminaire 102 can be further configured to emit light preferentially along a light emission direction 120 so as to define an emission lobe 132 that is divergent. It will be understood that in some embodiments, an intensity of light from the luminaire 102 as received at an illumination region 136 is dependent on relative spacing between the luminaire 102 and the illumination region 136.

FIG. 4C illustrates an embodiment of a luminaire 102 formed to have a curvature or bend in at least two axes X and Y. One embodiment as illustrated in FIG. 4C describes a generally convex curvature or folding configuration of a luminaire 102. However, it will be understood that in other embodiments, a luminaire 102 can be formed to exhibit a generally concave curvature or folding configuration.

It will be further understood that in various embodiments, a luminaire 102 can be configured to preferentially emit light in a substantially parallel, substantially convergent, or substantially divergent manner as considered along both or either an X and Y axis. For example, embodiments as illustrated in FIGS. 4A and 4B preferentially emit light along light emission directions 120 that is generally convergent about an X axis, for example, as in FIG. 4A, and preferentially generally divergent about a Y axis, for example, as in FIG. 4B. Embodiments of luminaires 102 can be further configured to substantially emit light in a parallel manner as considered about an X axis, for example, as in both FIGS. 4A and 4B and divergent or convergent manner in other directions, e.g., about Y axis. Additional embodiments of luminaire can be configured to preferentially emit light in a divergent manner along both an X and Y axis, for example as illustrated in FIG. 4C. Similarly embodiments of luminaire can be configured to preferentially emit light in a convergent or parallel manner along both an X and Y axis. As previously noted, additional embodiments of a luminaire 102 can be provided to have a generally concave curvature, in which case, light would be preferentially emitted from a luminaire 102 in a generally convergent manner about both an X and Y axis. It will be further understood that additional embodiments of a luminaire 102 can be configured to preferentially emit light in a converging manner about an axis and in a diverging manner about a Y axis.

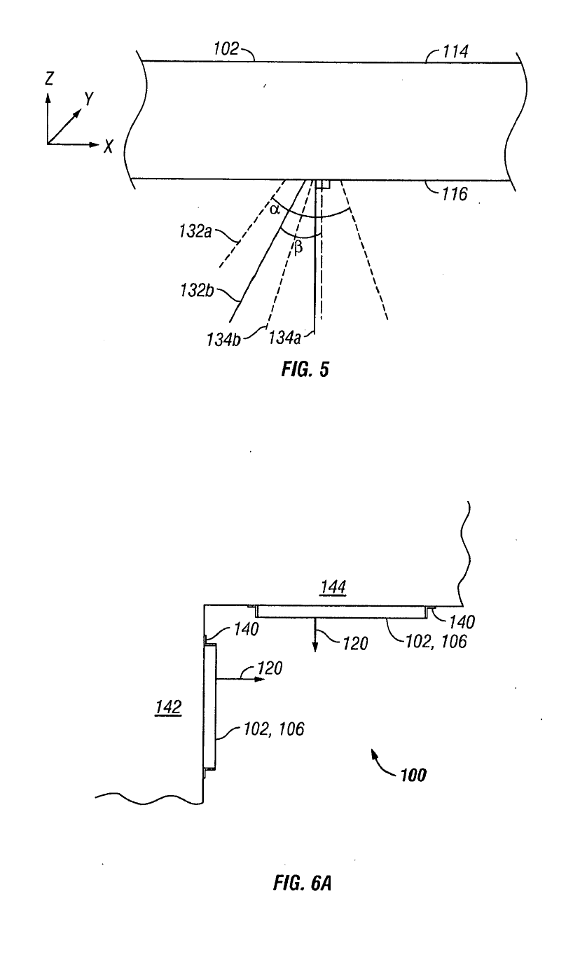

FIG. 5 illustrates further embodiments of a luminaire 102 comprising a waveguide configured to preferentially emit a portion of light substantially within a first emission lobe 132. In this embodiment, the first emission lobe 132a generally defines a cone or wedge defining an angle α. Alternatively the angular extent of the emission lobe may be different as illustrated by the second emission lobe 132b. The second emission lobe 132b defines a cone or wedge defining an angle β. It will be further understood that the angles α and β may define angles in one dimension with similar or different angles in, e.g., an orthogonal direction, and in some embodiments one or both of the angles α and β define a solid angle. The angles may correspond to the full width half maximum of the intensity pattern. For example, the central intensity drops off by half at an angle of α and β.

As can be seen in FIG. 5, one or both of a first and a second emission lobe 132a, 132b can be arranged, e.g., centered, at an angle with respect to a normal 134a to a surface of the luminaire 102. Also, one or both of a first and a second emission lobe 132a, 132b can be oriented at an inclination axis 134b angled with respect to the normal.

In some embodiments, one or more emission lobes of a luminaire 102 have a full width half maximum intensity of less than 60°. In some embodiments, a luminaire 102 is configured to emit light within one or more emission lobes 132 having a full width half maximum intensity of less than 30°. In some embodiments, a luminaire 102 is configured to preferentially emit light along light emission directions 120 or in an inclination axis 134 oriented at an angle of at least 20° with respect to a normal to a surface of the luminaire 102, for example, a forward surface 116.

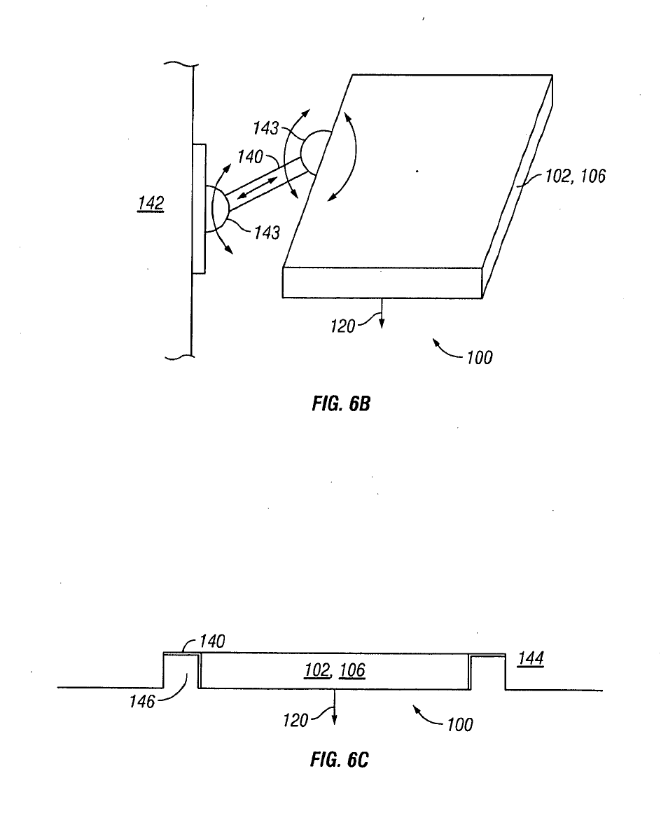

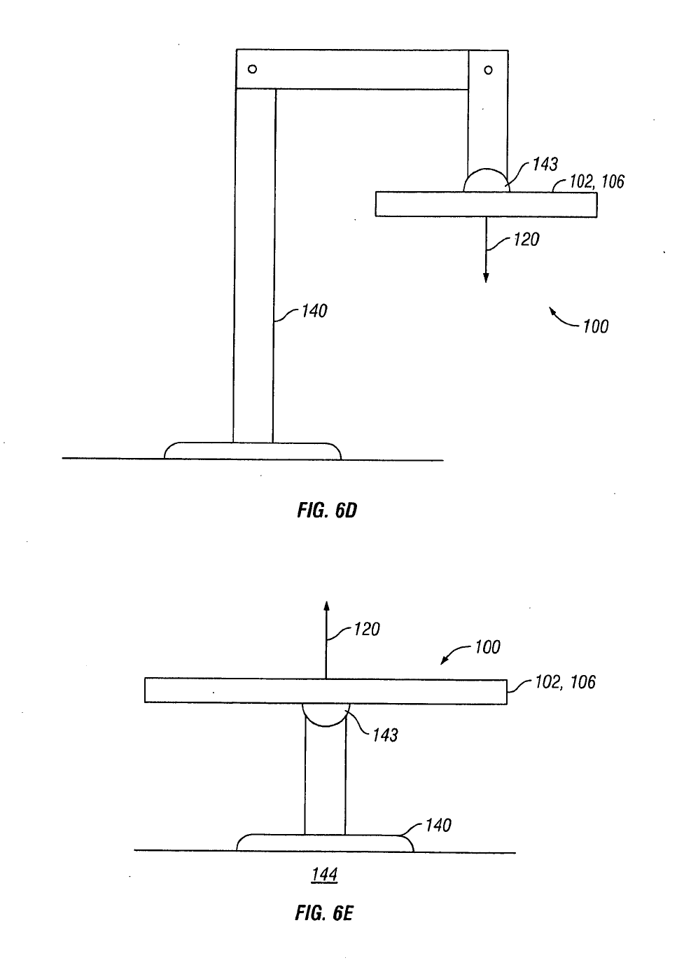

FIGS. 6A-6E illustrate a variety of embodiments of lighting assemblies 100 including a luminaire 102 with a waveguide 106. For simplicity of illustration, the illustrated embodiments of luminaires 102 in FIGS. 6A-6E are configured as substantially planar assemblies emitting light along a light emission direction 120 in a substantially parallel manner. However, it will be understood that any of the previously described and illustrated embodiments of luminaire 102 as well as other designs can be advantageously employed with one or more of the embodiments of the lighting assembly 100 as illustrated in FIGS. 6A-6E.

FIG. 6A illustrates embodiments of lighting assemblies 100 configured for attachment with one or more mounting fixtures 140 to one or more of a vertical structure 142 and a horizontal structure 144. In some embodiments, a lighting assembly 100 can be configured for attachment to generally planar vertical and/or horizontal structures 142, 144, such as interior or exterior walls, e.g. of a building, and/or ceilings. Due at least partially to the advantageously thin thickness dimension of certain embodiments of luminaire 102, a user or builder can attach one or more lighting assemblies 100 to such vertical and/or horizontal structures 142, 144 such that the lighting assembly 100 does not excessively protrude beyond the generally planar surface of the vertical or horizontal structure 142, 144. Embodiments of an lighting assembly 100 that can be configured generally as panel lighting can have a thickness comparable to or less than, for example, a framed painting or other artwork and can thus offer opportunities in interior and exterior design not possible or desirable with existing architectural lighting designs.

FIG. 6B illustrates embodiments of lighting assemblies 100 having a mounting fixture 140 provided with one or more joints 143. The mounting fixture 140 is illustrated in this embodiment as adapted for attachment to a vertical structure 142, however, it will be appreciated that additional embodiments of lighting assembly 100 can be provided adapted for attachment to a horizontal structure 144. The one or more joints 43 are configured to allow rotational movement about one or more axes to allow a user to adjust and orient the luminaire 102 such that the one or more light emission directions 120 are oriented along a desired path. In some embodiments, the mounting fixture 140 can have a telescoping or extending adjustment capability. Other configurations are also possible.

FIG. 6C illustrates an embodiment of lighting assembly 100 configured for attachment to one or both of a horizontal and/or vertical structure 144, 142. In this embodiment, the lighting assembly 100 is further configured such that a luminaire 102 can be attached via one or more mounting fixtures 140 within a recess 146 formed within, for example, a horizontal structure 144. In these embodiments, the recess 146 need only be formed to a depth of approximately the thickness of the luminaire 102. Due at least partially to the advantageously thin thickness dimension of luminaire 102 provided in various embodiments as described herein, offers increased flexibility and possibilities in mounting such an lighting assembly 100 as the depth required of a recess 146 is significantly less than would be required for existing lighting designs.

FIGS. 6D and 6E illustrate embodiments of lighting assemblies 100 that may, in some embodiments, be configured as portable fixtures. For example, a mounting fixture 140 of a lighting assembly 100 can be configured as a lamp stand to rest or support the assembly 100 on a ground or floor surface. In the embodiment illustrated in FIG. 6D, a mounting fixture 140 is further configured to support one or more luminaires 102 such that the light emitted from the luminaire 102 can be preferentially oriented along a light emission direction 120 directed generally downward. As previously noted, the assembly 100 can comprise one or more joints 143 such that the one or more light emission directions 120 can be adjusted or oriented as desired by a user for the requirements of a given application. The embodiment illustrated in FIG. 6E is at least partially similar to the embodiment illustrated in FIG. 6D, with the difference that the embodiment illustrated in FIG. 6E is adapted to orient and support one or more luminaires 102 such that a light emission direction 120 can be oriented generally upwards. The light can be directed at other angles in other embodiments.

Thus, various embodiments of a lighting assembly 100 can include a luminaire 102 having a light guide 106. The luminaire 102 and light waveguide 106 can be readily configured to have a relatively thin thickness dimension as compared to existing lighting designs to provide increased flexibility in mounting and installation configurations to a user. The luminaire 102 and waveguide 106 embodiments described herein also advantageously provide increased efficiency of light generation and emission to more efficiently generate and direct light towards one or more desired illumination regions 136. This provides the advantage to the user of reduced power consumption, reduced energy costs, extended battery life, and corresponding reduced environmental impact. Some embodiments of lighting assembly 100 can also provide the advantage that by preferentially directing light from a luminaire 102 along one or more light emission directions 120, such as within one or more emission lobes 132, a reduced amount of light is generated and emitted in other directions, thus avoiding illumination along what can be undesired paths.

Embodiments of the luminaire 102 also provide the advantage of improved heat dissipation. Embodiments employ total internal reflection to guide light within the waveguide 106. As light undergoes total internal reflection, substantially none of the light is lost and there is correspondingly substantially no heating associated with the total internal reflection. In contrast, light panels that might employ reflectors would experience a loss of approximately 5-10% at the reflective surfaces and a corresponding heating associated therewith.

Embodiments of the luminaire 102 offer the further advantage of a beneficial form factor for cooling. The luminaire 102 can readily be made in relatively large sizes. A large area of the luminaire 102 produces a small heat per area and facilitates rapid dissipation of any heat generated.

The lighting assembly may be used in a wide variety of applications including architectural applications. For example, the lighting assembly may be employed in buildings such as homes, offices, stores, residences, hospitals, schools, manufacturing facilities, etc. The lighting assemblies may be used indoors or outdoors. In various embodiments, the lighting assemblies may be used as overhead lighting, for example to replace panel lighting. The lighting assemblies therefore may be used as ceiling light, however, the lighting assembly may also be mounted in or on the wall. The lighting assemblies may be used for landscape lighting and/or street lights. The lighting assemblies may be used for step lights, flood lights, up lights, down lights, path lights, and the like.

The use of the lighting assembly 100 is not limited to buildings. The lighting assembly 100 may be employed in other structures as well. The lighting assemblies 100 may be used for vehicles as well. The lighting assembly 100 may be used in or on automobile, truck, or a bus as well as spacecraft, aircraft, or a watercraft. Such lighting assemblies 100 may be used to light the cabin inside as well as for lighting on the outside of the vehicles. Other examples of vehicles include bicycles, strollers, trailers, or carts.

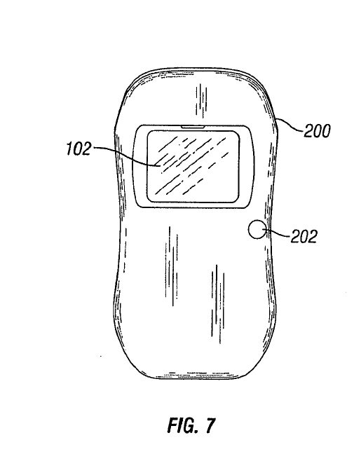

Embodiments of the luminaire 102 can be used in electronic devices 200 as illustrated in FIG. 7. For example, a luminaire 102 can be attached to or formed with handheld devices 200 such as cell phones, personal digital assistants, laptop computers, and the like. The luminaires 102 can provide inexpensive efficient “flashlight” functionality to increase the utility of such devices 200. In various embodiments, one or more luminaires 102 can be arranged adjacent and/or opposite other features of the electronic device 200, such as displays, keyboards, speakers, user controls, and the like. In some embodiments, a dedicated control switch 202 is provided to activate/deactivate the luminaire 102. In other embodiments, functionality of the control switch 202 is provided by other controls, for example a particular pattern of activation of keys of a keyboard or actuation of a touchscreen control.

The luminaires 102 can be fixedly attached or formed with the electronic device 200. In other embodiments, the luminaire 102 can be movable, such as attached to the electronic device 200 in a hinged and/or sliding manner. The luminaire 102 can be formed as a component of the electronic device as original equipment and/or can be formed as an aftermarket accessory that a user can add to an existing electronic device 200. Still other applications are possible.

In some embodiments, the luminaire 102 can be provided in addition to one or more displays of a device 200. In some embodiments a display of a device 200 can be illuminated, for example for use in low light conditions. In at least some embodiments, a luminaire 102 of a device 200 can output more light than a display of the device 200. In some embodiments, the light output of one or both of a luminaire and/or a display can be adjustable.

A wide variety of variation in configuration, design, and arrangement of the lighting assembly is possible. Films, layers, components, and/or elements may be added, removed, or rearranged. Additionally, processing steps may be added, removed, or reordered. Also, although the terms film and layer have been used herein, such terms as used herein include film stacks and multilayers. Such film stacks and multilayers may be adhered to other structures using adhesive or may be formed on other structures using deposition techniques or in other manners.

Although the above disclosed embodiments of the present teachings have shown, described and pointed out the fundamental novel features of the invention as applied to the above-disclosed embodiments, it should be understood that various omissions, substitutions, and changes in the form of the detail of the devices, systems and/or methods illustrated may be made by those skilled in the art without departing from the scope of the present teachings. Components, devices, and features and may be added, removed, or rearranged in different embodiments. Similarly processing steps be added, removed, or reordered in different embodiments. Accordingly, the scope of the invention should not be limited to the foregoing description but should be defined by the appended claims.

What is claimed is:

1. Architectural lighting comprising:
(a) a luminaire comprising:
a light source;
a waveguide having forward and rearward surfaces, said waveguide disposed with respect to said light source such that light from the light source is input into said waveguide and guided therein, said waveguide including a plurality of turning features that turn said light guided within said waveguide out said forward surface; and
(b) one or more mounting fixtures for mounting said luminaire on an architectural structure.

2. The architectural lighting of claim 1, wherein said light source comprises a fluorescent light or light emitting diode.

3. The architectural lighting of claim 1, further comprising a light bar disposed with respect to light source to receive light therefrom, said light bar disposed with respect to said waveguide to direct light received from said light source into said light guide.

4. The architectural lighting of claim 1, wherein said waveguide comprises a sheet of material that is substantially optically transmissive material.

5. The architectural lighting of claim 4, wherein said sheet comprises plastic or glass.

6. The architectural lighting of claim 1, wherein said turning features comprise prismatic, holographic, or diffractive features.

7. The architectural lighting of claim 1, wherein said turning features are formed in a film laminated on a substrate or are disposed in a substrate.

8. The architectural lighting of claim 1, wherein said waveguide has a thickness of at least ½ inch.

9. The architectural lighting of claim 8, wherein said waveguide has a thickness of at least 20 mm.

10. The architectural lighting of claim 1, wherein said waveguide has an area greater than 500 square inches.

11. The architectural lighting of claim 10, wherein said waveguide has an area greater than 800 square inches.

12. The architectural lighting of claim 1, wherein said light output from said forward surface is at least 25 watts of visible optical power.

13. The architectural lighting of claim 12, wherein said light output from said forward surface is at least 50 watts of visible optical power.

14. The architectural lighting of claim 13, wherein said light output from said forward surface is at least 75 watts of visible optical power.

15. The architectural lighting of claim 1, wherein said turning features have a shape such that said light output from said forward surface is substantially within a lobe defined by a range of angles less than 1 steradian (sr).

16. The architectural lighting of claim 15, wherein said turning features have a shape such that said light output from said forward surface is substantially within a lobe defined by a range of angles less than 0.5 sr.

17. The architectural lighting of claim 15, wherein said lobe is substantially symmetric about an axis that is oriented at an angle with respect to the normal to said forward surface.

18. The architectural lighting of claim 17, wherein said axis is orientated at an angle of at least 20° with respect to the normal to said forward surface.

19. The architectural lighting of claim 1, wherein said turning features have a shape such that said light output from said forward surface is substantially within a plurality of lobes with a dip in intensity therebetween.

20. The architectural lighting of claim 19, wherein at least one of said lobes is centered about an axis that is at an angle with respect to the normal to said forward surface.

21. The architectural lighting of claim 20, wherein said axis is at an angle of at least 20° with respect to the normal to said forward surface.

22. The architectural lighting of claim 19, wherein said plurality of lobes comprises at least first and second lobes that are centered about first and second different axes, which are each angled with respect to the normal to said forward surface.

23. The architectural lighting of claim 1, wherein said turning features have a shape and orientation such that said light output from said forward surface has an asymmetric angular distribution.

24. The architectural lighting of claim 1, comprising overhead lighting.

25. The architectural lighting of claim 1, comprising a ceiling light or a wall light.

26. The architectural lighting of claim 1, comprising outdoor building lighting.

27. Architectural lighting comprising:
(a) a luminaire comprising:
means for producing light;
means for guiding light disposed with respect to said light producing means such that light from the light producing means is input into said light guiding means and guided therein, said light guiding means including a means for turning light that turns said light guided within said light guiding means out said light guiding means; and
(b) means for mounting said luminaire on an architectural structure.

28. The architectural lighting of claim 27, wherein said light producing means comprises a light source.

29. The architectural lighting of claim 27, wherein said light guiding means comprises a waveguide.

30. The architectural lighting of claim 27, wherein said light turning means comprises a plurality of turning features.

31. The architectural lighting of claim 27, wherein said mounting means comprises one or more mounting fixtures.

32. A method of manufacturing architectural lighting, the method comprising:
providing a luminaire comprising:
a light source; and
a waveguide having forward and rearward surfaces, said waveguide disposed with respect to said light source such that light from the light source is input into said waveguide and guided therein, said waveguide including a plurality of turning features that turn said light guided within said waveguide out said forward surface; and
providing one or more mounting fixtures for mounting said luminaire on an architectural structure.

33. The method of claim 32, wherein providing the luminaire comprises providing the light source as a fluorescent light or light emitting diode.

34. The method of claim 32, wherein providing the luminaire comprises providing the waveguide as a sheet of material that is substantially optically transmissive material.

35. A luminaire comprising:
a light source;
a waveguide having forward and rearward surfaces, said waveguide disposed with respect to said light source such that light from the light source is input into said waveguide and guided therein, said waveguide including a plurality of turning features that turn said light guided within said waveguide out said forward surface; and
a lamp stand for supporting said luminaire.

36. The luminaire of claim 35, comprising at least one of landscape lighting, street light, and street lights.

37. The luminaire of claim 35, wherein said luminaire comprises step lights, flood lights, up lights, down lights, path lights.

38. A vehicle comprising:
a frame; and
a luminaire supported by said frame, said luminaire comprising
a light source; and
a waveguide having forward and rearward surfaces, said waveguide disposed with respect to said light source such that light from the light source is input into said waveguide and guided therein, said waveguide including a plurality of turning features that turn said light guided within said waveguide out said forward surface.

39. The vehicle of claim 38, comprising an automobile, truck, or a bus.

40. The vehicle of claim 38, comprising a spacecraft, aircraft, or a watercraft.

41. The vehicle of claim 38, comprising a bicycle, stroller, trailer, or cart.
